(19) United States
(12) Patent Application Publication
(10) Pub. No.: US 2015/0356625 A1
(43) Pub. Date: Dec. 10, 2015

(54) METHOD FOR PROVIDING MARKETING GIFTS THROUGH BUSINESS-TO-CONSUMER WEBSITES

(71) Applicants: XIANCAI PAN, Richmond (CA); FENG YE, Richmond (CA)

(72) Inventors: XIANCAI PAN, Richmond (CA); FENG YE, Richmond (CA)

(21) Appl. No.: 14/733,950

(22) Filed: Jun. 8, 2015

Related U.S. Application Data
(60) Provisional application No. 62/008,935, filed on Jun. 6, 2014.

(51) Int. Cl. G06Q 30/02

(52) U.S. Cl. CPC G06Q 30/0269; G06Q 30/0214; G06Q 30/0277

(57) ABSTRACT

In one aspect, a method of providing marketing gifts through business-to-consumer websites may include steps of: marketer selecting a business-to-consumer (B2C) website; marketer providing predetermined conditions to the B2C website to select a group of gift receivers who may be interested in the gifts provided by the marketer; marketer providing a predetermined amount of gifts to the B2C website; upon receiving the predetermined conditions, the B2C website selecting the gift receivers who may be interested in the gifts provided by the marketer; when one of the gift receivers shopping on the B2C website, the B2C website providing one or more gifts provided by the marketer to the gift receiver; the B2C website sending the gift(s) selected by the gift receiver along with the purchased items to the person.

### CROSS-REFERENCE TO RELATED APPLICATIONS

The present invention claims priority under 35 U.S.C. §119 (e) to U.S. Provisional Patent Application Ser. No. 62/008,935, filed on Jun. 6, 2014, the entire contents of which are hereby incorporated by reference.

### FIELD OF THE INVENTION

The present invention relates to a method for providing a marketing gift(s) or product samples, and more particularly to a method for providing a marketing gift(s) or product samples through business-to-consumer websites.

### BACKGROUND OF THE INVENTION

Electronic commerce (E-commerce) is an increasingly popular way of conducting business, typically, but not exclusively, including activities such as browsing for items; comparing product aspects such as price, color, warranties, and the like for multiple items; inspecting product details of an item; purchasing one or more items; and the like. More and more vendors are making their products and services available over electronic networks, such as the Internet, and computer users have embraced electronic commerce as a legitimate shopping environment.

Both vendors and computer users greatly benefit from electronic commerce in a variety of ways. For example, users do not have to travel to a number of vendor locales to purchase a given item. Rather, a user can now purchase a desired item from the convenience of his or her home. Furthermore, users can quickly compare a wide variety of similar products and prices from a number of vendors in order to make an informed choice in their purchases rather than spending an entire afternoon in comparison shopping. Vendors are benefited in that they can reach a much larger group of customers than those who reside in their geographic vicinity.

Business-to-customer (B2C) marketing refers to the tactics and best practices used to promote products and services among consumers. Like most forms of marketing, technology has greatly expanded the number of channels that Business-to-customer (B2C) marketers must use in their campaigns. In the era of E-commerce, the web has provided a critical medium for the delivery of relevant content and information designed to educate prospects and generate demand, rather than simply promote brands. Branded content is increasingly part of consumers' shopping process, and it is reported that more than one-quarter of all consumers going to business websites for information prior to making a purchase.

Currently, global B2C E-commerce is very mature and has a huge body of customers, which provides a solid foundation to the present invention, namely providing marketing gifts through B2C websites. According to eMarketer (www.eMarketer.com), total sales of B2C E-commerce was 1200 billion dollars in 2013, which increased 17% comparing with 2012. Furthermore, there would be 1.03 billon people conducted business through B2C e-commerce, and currently in the United States, there are 156 million people shopping online. The table below illustrates the B2C E-commerce sales worldwide.

So far, the B2C websites make profits by sales of merchandises and advertisement. The distribution channels are all for the merchandises ordered by the customers. No B2C companies use the distribution channel to make other profits like sending the marketing gifts, which may be a waste.

The Advertising Specialty Institute® (ASI) released its annual sales analysis for the US promotional products industry, showing total sales during 2013 of $20.5 billion, up 5.3% from 2012, with continued strong sales forecast throughout 2014. One of the conventional methods for providing marketing gifts is to randomly providing marketing gifts to people walking on the street or randomly sending such gifts through regular mail. This conventional strategy is disadvantageous because it is less selective and does not specifically focus on targeted consumers. When a person receives a marketing gift that does not interest him/her, he/she usually discards it right away, which causes waste to the gift provider and it is not considered an efficient marketing technique.

Therefore, there remains a need for a new and improved method for providing marketing gifts to overcome the problems in conventional B2C strategies stated above.

### SUMMARY OF THE INVENTION

It is an object of the present invention to provide a method for sending marketing gifts or product samples through Business-to-Consumer (B2C) websites to more precisely target on consumers who may be interested in the gifts.

It is another object of the present invention to utilize existing B2C distribution channel to make profits by distributing marketing gifts.

It is still another object of the present invention to provide a method for sending marketing gifts through B2C websites to save the marketing costs, including advertisement costs, labor costs, delivery costs, etc.

It is a further object of the present invention to provide different free marketing gifts to the consumers constantly, which may increase the consumer's motivation to continuously shop at this B2C website to further increase the sales number of the B2C website.

It is still a further object of the present invention to provide a method for sending marketing gifts or product samples through B2C websites to promote online shopping and further increase sales numbers associated with the marketing gifts.

It is still a further object that the B2C websites determine the types and numbers of the marketing gifts and invites gifts manufacturers to manufacture the marketing gifts, so as to increase the participation of the business especially the mid-size companies.

In one aspect, a computer-implemented method of providing marketing gifts through business-to-consumer websites may include steps of: marketer selecting a business-to-consumer (B2C) website; marketer providing predetermined conditions to the B2C website to select a group of gift receivers who may be interested in the gifts provided by the marketer; marketer providing a predetermined amount of gifts to the B2C website; upon receiving the predetermined conditions, the B2C website selecting the gift receivers who may be interested in the gifts provided by the marketer; when one of the gift receivers shopping on the B2C website, the B2C website providing one or more gifts provided by the marketer to the gift receiver; the B2C website sending the gift(s) selected by the gift receiver along with the purchased items to the person.

In one embodiment, the predetermined conditions may include, but not limited to, gift size/weight, targeted areas to send the gifts, targeted age of people to receive the gifts, gift receivers' hobbies/income, sex, title, gift receivers' shopping histories, etc., which can be referred to the “big data” from the B2C website. In other words, the present invention is taking advantage of the B2C websites' big data to more precisely target potential gift receivers to efficiently deliver the marketing gifts and prevent waste of marketing resources. In another embodiment, the B2C websites may include, but not limited to Amazon, eBay, COSTCO, zappos, Groupon, Walmart, etc.

To increase more business participation with the marketing strategy in the present invention, the B2C websites may invite other business entities to manufacture at least a portion of the marketing gifts, so the B2C websites can customize the marketing gifts according to the predetermined conditions including gift size/weight, targeted areas to send the gifts, targeted age of people to receive the gifts, gift receivers' hobbies/income, sex, title, gift receivers' shopping histories, etc., as mentioned above, and the gift manufacturers can get involved in making at least a portion of the gifts if they see a need. More specifically, instead of receiving the marketing gifts from the marketer, the B2C websites can invite one or more gift manufacturers to make the gifts according to the “big data” possessed by the B2C websites, which may include steps of: B2C websites customizing the marketing gifts according to the predetermined conditions; inviting one or more gift manufacturers to manufacture the marketing gifts; and each gift manufacturers selecting at least a portion of the marketing gift to manufacture.

Comparing with conventional B2C marketing strategies, the method provided in the present invention is advantageous because the B2C websites have existing customer database that can be further filtered to select a group of people that may be interested to a specific kind of gift(s). When the selected group people receive the gift, they may use or keep the gifts instead of discarding the gifts. Furthermore, they may further purchase the products related to the gifts which may be beneficial to both the B2C websites and the gift provider, namely a win-win situation.

Moreover, if one gift becomes popular among people, the gift can become a merchandise for sale, which is also beneficial to the B2C website that provides the gift and may invite more people to visit the B2C website to increase other potential sales.

### BRIEF DESCRIPTION OF THE DRAWINGS

FIG. 1 illustrates a method of providing marketing gifts through business-to-consumer websites in the present invention.

FIG. 2 illustrates one embodiment of the method of providing marketing gifts through business-to-consumer websites in the present invention.

FIG. 3 illustrates another embodiment of the method of providing marketing gifts through business-to-consumer websites in the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

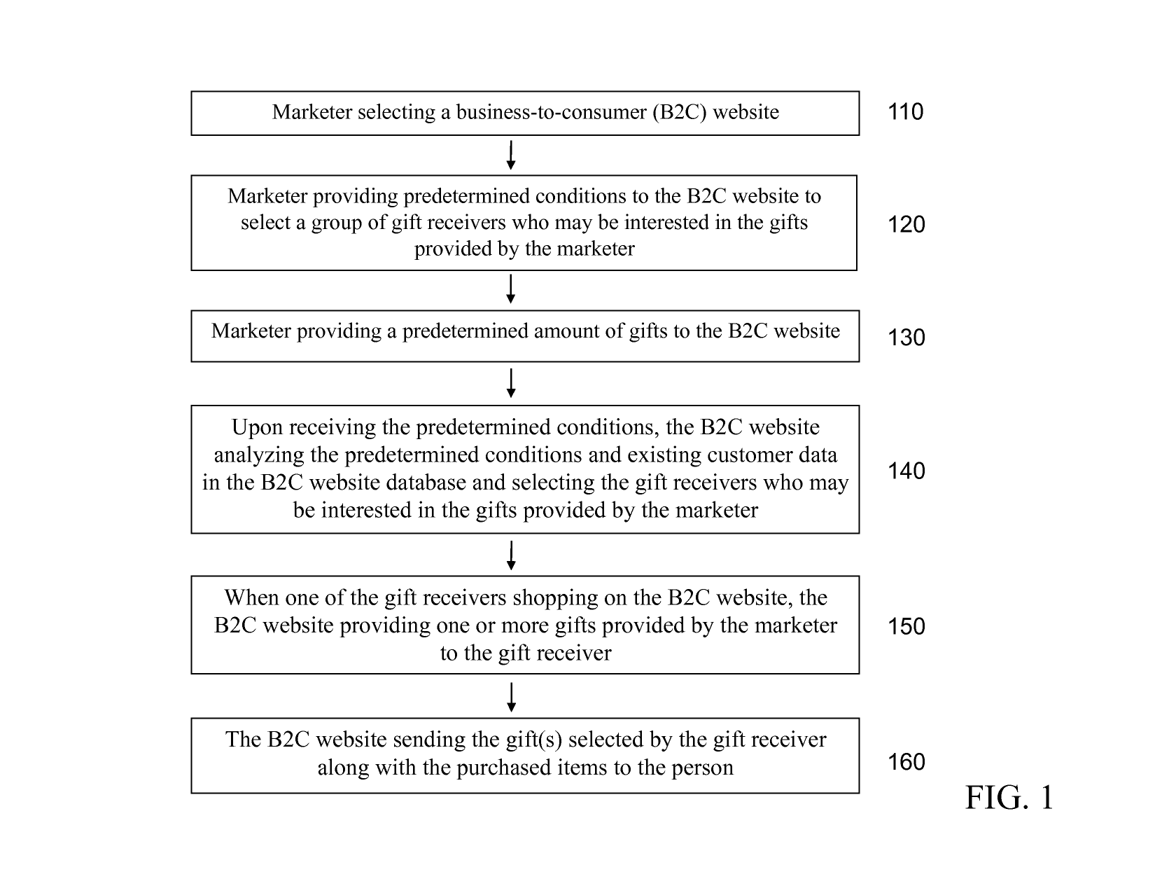

In one aspect, as shown in FIG. 1, a computer-implemented method of providing marketing gifts through business-to-consumer websites may include steps of: marketer selecting a business-to-consumer (B2C) website 110; marketer providing predetermined conditions to the B2C website to select a group of gift receivers who may be interested in the gifts provided by the marketer 120; marketer providing a predetermined amount of gifts to the B2C website 130; upon receiving the predetermined conditions in step 120, the B2C website analyzing the predetermined conditions and existing customer data in the B2C website database and selecting the gift receivers who may be interested in the gifts provided by the marketer 140; when one of the gift receivers shopping on the B2C website, the B2C website providing one or more gifts provided by the marketer to the gift receiver 150; the B2C website sending the gift(s) selected by the gift receiver along with the purchased items to the person 160.

Big data is an evolving term that describes any voluminous amount of structured, semi-structured and unstructured data that has the potential to be mined for information. Although big data doesn't refer to any specific quantity, the term is often used when speaking about petabytes and exabytes of data. Big data is changing the way people within organizations work together, and creating a culture in which business and IT leaders must join forces to realize value from all data. In one embodiment, the predetermined conditions in step 120 may include, but not limited to, gift size/weight, targeted areas to send the gifts, targeted age of people to send the gifts, gift receivers' hobbies/income, sex, title, gift receivers' shopping histories, etc., which can be referred to the “big data” from the B2C website. In other words, the present invention is taking advantage of the B2C websites' big data to more precisely target potential gift receivers to efficiently deliver the marketing gifts and prevent waste of marketing resources. In another embodiment, the B2C websites may include, but not limited to Amazon, eBay, COSTCO, zappos, Groupon, Walmart, etc.

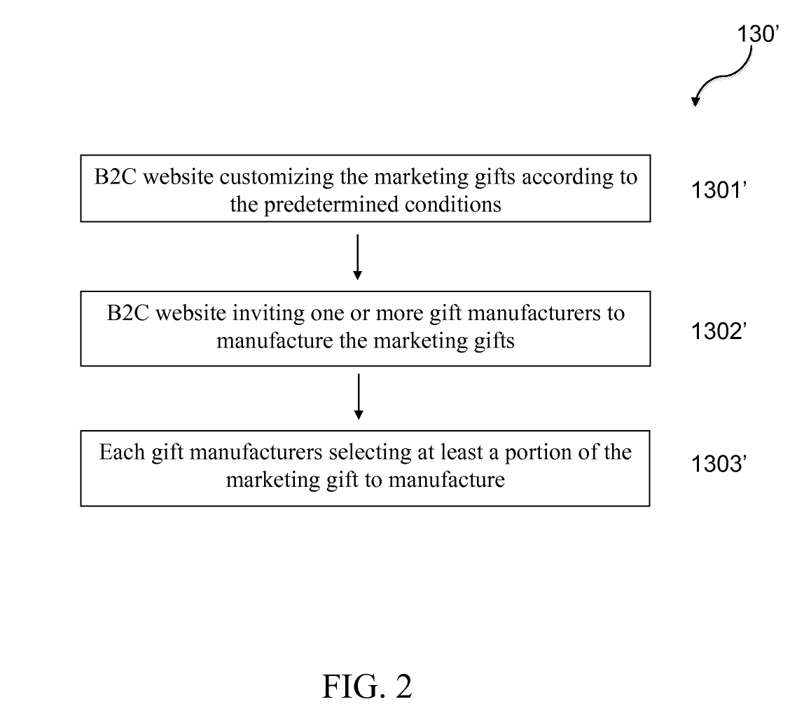

To increase more business participation with the marketing strategy in the present invention, the marketer may invite other business entities to manufacture at least a portion of the marketing gifts, so the B2C marketer can customize the marketing gifts according to the predetermined conditions including gift size/weight, targeted areas to send the gifts, targeted age of people to receive the gifts, gift receivers' hobbies/income, sex, title, gift receivers' shopping histories, etc., as mentioned above, and the gift manufacturers can get involved in making at least a portion of the gifts if they see a need. More specifically, instead of receiving the marketing gifts from the marketer, the B2C websites can invite one or more gift manufacturers to make the gifts according to the “big data” possessed by the B2C websites (step 130′), which may include steps of: B2C websites customizing the marketing gifts according to the predetermined conditions 1301′; inviting one or more gift manufacturers to manufacture the marketing gifts 1302′; and each gift manufacturers selecting at least a portion of the marketing gift to manufacture 1303′, as shown in FIG. 2. The B2C website can also provide a platform for the gift manufacturers to sign up for manufacturing a specific portion of the gift.

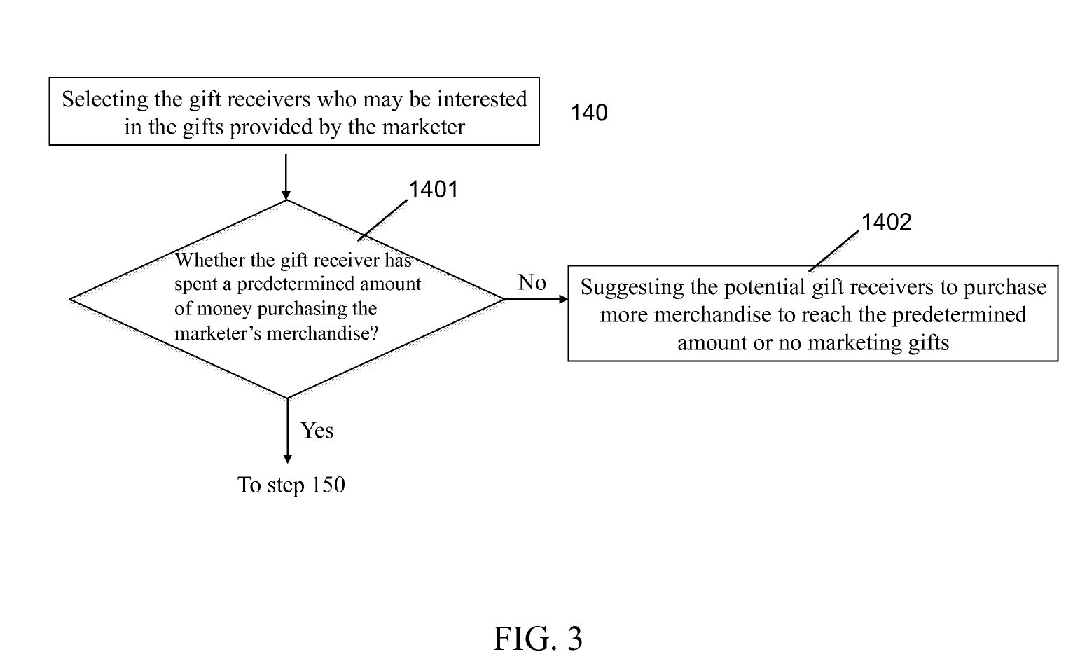

In one embodiment, the gift receivers can receive the marketing gifts without for free. In another embodiment, the gift receivers may have to spend a predetermined amount of money purchasing the marketer's merchandise. As shown in FIG. 3, the step of selecting the gift receivers who may be interested in the gifts provided by the marketer 140 may include steps of determining if the gift receiver has spent a predetermined amount of money purchasing the marketer's merchandise 1401; and if the gift receiver has not spent a predetermined amount of money (e.g. $100 on the marketer's merchandise), step 1402 may suggest the potential gift receivers to purchase more merchandise to reach the predetermined amount or no marketing gifts.

Comparing with conventional B2C marketing strategies, the method provided in the present invention is advantageous because the B2C websites have existing customer database that can be further filtered to select a group of people that may be interested to a specific kind of gift(s). When the selected group people receive the gift, they may use or keep the gifts instead of discarding the gifts. Furthermore, they may further purchase the products related to the gifts which may be beneficial to both the B2C websites and the gift provider, namely a win-win situation.

Also, sending the gifts to a selected group of people who may be interested can prevent waste of the resources. If the gifts are randomly distributed like conventional B2C marketing strategy, people who are not interested in the gifts may just throw them away, which is not only a waste of resources, but also increase the costs of the marketer. And if one gift becomes popular among people, the gift can become a merchandise for sale, which is also beneficial to the B2C website that provides the gift and may invite more people to visit the B2C website to increase other potential sales.

Moreover, the present invention is advantageous because it is taking advantage of the B2C websites' big data to more precisely target potential gift receivers to efficiently deliver the marketing gifts and prevent waste of marketing resources. It also creates opportunities for the gift manufacturers to participate in manufacturing the marketing gifts, so the B2C websites can lower their own operation costs and risks.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A computer-implemented method of providing marketing gifts through business-to-consumer websites comprising steps of:
a marketer selecting a business-to-consumer (B2C) website;
the marketer providing predetermined conditions to the B2C website to select a group of gift receivers who may be interested in the gifts provided by the marketer;
the marketer providing a predetermined amount of gifts to the B2C website;
upon receiving the predetermined conditions, the B2C website analyzing the predetermined conditions and existing customer data in the B2C website database and selecting the gift receivers who may be interested in the gifts provided by the marketer;
when one of the gift receivers shopping on the B2C website, the B2C website providing one or more gifts provided by the marketer to the gift receiver; and
the B2C website sending the gift(s) selected by the gift receiver along with the purchased items to the person.

2. The computer-implemented method of providing marketing gifts through business-to-consumer websites of claim 1, wherein the B2C websites includes Amazon, eBay, COSTCO, zappos, Groupon, and Walmart.

3. The computer-implemented method of providing marketing gifts through business-to-consumer websites of claim 1, wherein the gift size/weight; targeted areas to send the gifts; targeted age of people to receive the gifts; gift receivers' hobbies/income, sex, title; and gift receivers' shopping histories.

4. The computer-implemented method of providing marketing gifts through business-to-consumer websites of claim 1, wherein the marketing gifts are free to all gift receivers.

5. The computer-implemented method of providing marketing gifts through business-to-consumer websites of claim 1, wherein the step of selecting the gift receivers who may be interested in the gifts provided by the marketer includes a step of determining if the gift receiver has spent a predetermined amount of money purchasing the marketer's merchandise.

6. The computer-implemented method of providing marketing gifts through business-to-consumer websites of claim 5, wherein if the potential gift receivers has not spent a predetermined amount of money on the marketer's merchandise, the step of selecting the gift receivers further includes a step of suggesting the potential gift receivers to purchase more merchandise to reach the predetermined amount or no marketing gifts.

7. A computer-implemented method of providing marketing gifts through business-to-consumer websites comprising steps of:
a marketer selecting a business-to-consumer (B2C) website;
the marketer providing predetermined conditions to the B2C website to select a group of gift receivers who may be interested in the gifts provided by the marketer;
upon receiving the predetermined conditions, the B2C website analyzing the predetermined conditions and existing customer data in the B2C website database and selecting the gift receivers who may be interested in the gifts provided by the marketer;
the B2C website producing the marketing gifts;
when one of the gift receivers shopping on the B2C website, the B2C website providing one or more gifts provided by the marketer to the gift receiver; and
the B2C website sending the gift(s) selected by the gift receiver along with the purchased items to the person.

8. The computer-implemented method of providing marketing gifts through business-to-consumer websites of claim 7, wherein the step of the B2C website producing marketing gifts includes steps of: the B2C website customizing the marketing gifts according to the predetermined conditions; inviting one or more gift manufacturers to manufacture the marketing gifts; each gift manufacturers selecting at least a portion of the marketing gift to manufacture.

9. The computer-implemented method of providing marketing gifts through business-to-consumer websites of claim 7, wherein the B2C websites includes Amazon, eBay, COSTCO, zappos, Groupon, and Walmart.

10. The computer-implemented method of providing marketing gifts through business-to-consumer websites of claim 7, wherein the gift size/weight; targeted areas to send the gifts; targeted age of people to receive the gifts; gift receivers' hobbies/income, sex, title; and gift receivers' shopping histories.

11. The computer-implemented method of providing marketing gifts through business-to-consumer websites of claim 7, wherein the marketing gifts are free to all gift receivers.

12. The computer-implemented method of providing marketing gifts through business-to-consumer websites of claim 7, wherein the step of selecting the gift receivers who may be interested in the gifts provided by the marketer includes a step of determining if the gift receiver has spent a predetermined amount of money purchasing the marketer's merchandise.

13. The computer-implemented method of providing marketing gifts through business-to-consumer websites of claim 12, wherein if the potential gift receivers has not spent a predetermined amount of money on the marketer's merchandise, the step of selecting the gift receivers further includes a step of suggesting the potential gift receivers to purchase more merchandise to reach the predetermined amount or no marketing gifts.
